(19) United States
(12) Patent Application Publication
(10) Pub. No.: US 2008/0247760 A1
(43) Pub. Date: Oct. 9, 2008

(54) SYSTEM FOR WIRELESS ALARM REPORTING

(75) Inventors: Eugene L. EDMON, Danville, CA (US); Bryan WALKER, Round Rock, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/733,052

(22) Filed: Apr. 9, 2007

(51) Int. Cl. H04B 10/00

(52) U.S. Cl. 398/128

(57) ABSTRACT

A system for wireless alarm reporting is disclosed. A system that incorporates teachings of the present disclosure may include, for example, a network interface device (NID) having a translator element to convert an optical signal supplied by a communication system to one or more electrical signals supplied to one or more communication devices served by the NID, and a wireless transmitter to transmit a notice to a portable alerting device responsive to a UPS asserting an alarm. Additional embodiments are disclosed.

### FIELD OF THE DISCLOSURE

The present disclosure relates generally to communication systems, and more specifically to a system for wireless alarm reporting.

### BACKGROUND

As higher bandwidth media services are deployed to residences and commercial enterprises, telecommunication service providers are installing network interface devices (NIDs) that can process communication signals between a central office and said residences or commercial enterprises. To provide subscribers uninterrupted services, the NIDs generally come with an uninterrupted power supply (UPS) that can provide temporary power to the NID in the event of a power outage. Traditionally, the UPS is mounted inside a residence or commercial enterprise which allows subscribers to easily notice and respond to faulty power condition alarms generated by the UPS. However, when the UPS is located in an inaccessible location, or outside the residence, the customer cannot conveniently access or respond to alarms generated by the UPS.

A need therefore arises for a system for wireless alarm reporting.

### BRIEF DESCRIPTION OF THE DRAWINGS

FIG. 1 depicts an exemplary embodiment of a communication system;

FIG. 2 depicts an exemplary embodiment of a wireless alarm system in the communication system;

FIG. 3 depicts an exemplary method operating in the wireless alarm system of FIG. 2; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system for wireless alarm reporting.

In a first embodiment of the present disclosure, a network interface device (NID) can have a translator element that converts an optical signal supplied by a communication system to one or more electrical signals supplied to one or more communication devices operating in a building served by the NID, an uninterrupted power supply (UPS) coupled to an AC power source, and a wireless transmitter coupled to the UPS. The wireless transmitter can transmit a notice to a portable alerting device located in the building responsive to the UPS asserting an alarm.

In a second embodiment of the present disclosure, a UPS can have one or more battery cells to supply power to a NID during a power outage, an AC to DC converter to charge the one or more battery cells and power the NID, and a controller element to monitor operations of the UPS and assert one or more alarms when a malfunction is detected. The NID can be coupled to an optical communications interface and supply communication services to one or more communication devices. The NID can detect the one or more alarms and wirelessly transmit the alarms to a portable alerting device.

In a third embodiment of the present disclosure, a portable alerting device can have a wireless receiver, an alert element, and a controller element to receive from the wireless receiver an alarm notice associated with an uninterrupted power supply (UPS) and direct the alert element to assert an alert.

In a fourth embodiment of the present disclosure, a NID can have a translator element to convert an optical signal supplied by a communication system to one or more electrical signals supplied to one or more communication devices served by the NID, and a wireless transmitter to transmit a notice to a portable alerting device responsive to a UPS asserting an alarm.

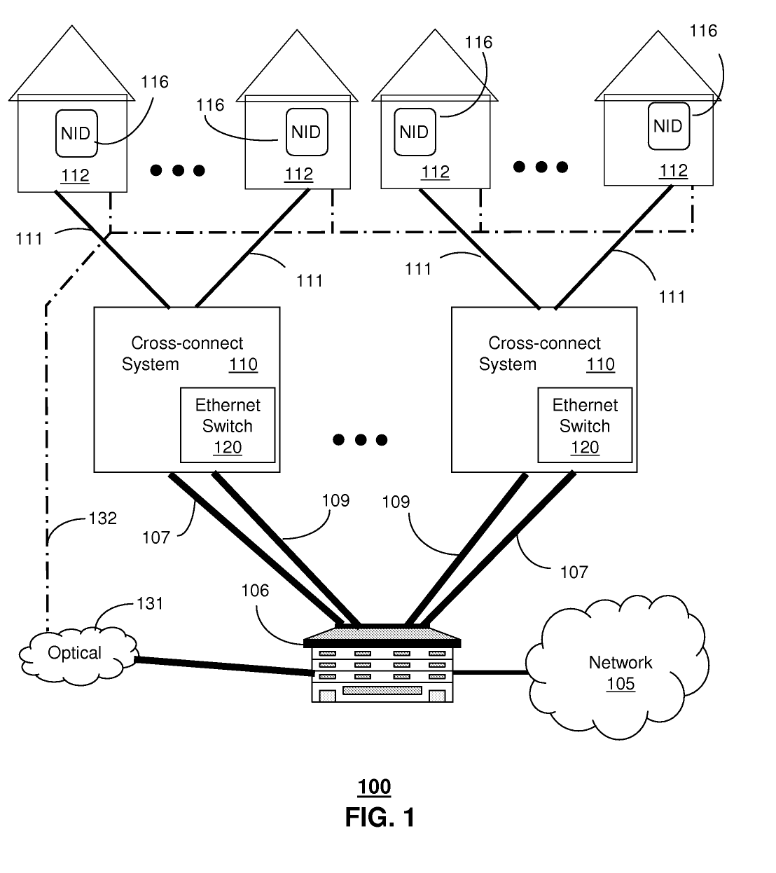

FIG. 1 depicts an exemplary block diagram of a communication system 100. The communication system 100 can comprise a central office (CO) 106 and one or more cross-connect systems (CCSs) 110 that can each be coupled to one or more buildings 112, such as a home or commercial complex. The CO 106 can house common network switching equipment (e.g., circuit-switched and/or packet-switched switches and routers) for distributing local and long-distance telecommunication services supplied by network 105 to buildings 112 by way of the CCSs 110. For illustration purposes only, buildings 112 will be referred to herein as residences 112. However, it should be understood by one of ordinary skill in the art that the buildings 112 can refer to any premise or areas that utilizes communication services.

Telecommunication services of the CO 106 can include traditional POTS (Plain Old Telephone Service) or other services such as HDTV, xDSL, VoIP (Voice over Internet Protocol), IPTV (Internet Protocol Television), Internet services, and so on. Links 107 can be twisted copper pairs for distributing power to the CCSs 110. In one embodiment, links 107 can be coupled to local commercial power near the CCSs 110 supplied by, for example, a utility company. The present disclosure contemplates other structures and techniques for providing power to the CCS 110. The CCS 110 can be coupled to optical and/or electrical cables 109 supplied by the CO 106, which carries any one or more of the aforementioned communication services. These services can be processed in part by active circuits such as Ethernet switches 120 in the CCS 110. Each cable 109 can carry communication lines numbering in the tens or hundreds. The CCS 110 serves to distribute portions of the cables 109 as communication links 111 to Network Interface Devices 116 (NID) coupled to the residences 112.

The communication links 111 can provide circuit-switched and/or packet-switched services to the NID 116. The NID 116 can provide multiple interface functions such as code conversion, protocol conversion, and buffering. The CCS 110 can therefore serve as a local cross-connect system for unbundling communication lines in cable 109. In one embodiment, each of the CCSs 110 can provide xDSL ports to the NIDs 116. xDSL ports in the present context can mean any present or future derivative of a digital subscriber line (e.g., VDSL, ADSL, and so on).

Alternatively, the communication system 100 can provide optical communications directly to the NIDs 116 by way of optical links 132. The optical network 131 can supply optical communication services to the NIDs 116 such as synchronous optical network (SONET), synchronous digital hierarchy (SDH), fiber distributed data interface (FDDI), passive optical networks (PONs), wave division multiplexing (WDM), resilient packet ring and optical Ethernet—just to mention a few. A switch or router can serve as a central relay for bringing the optical fiber to the NIDs 116.

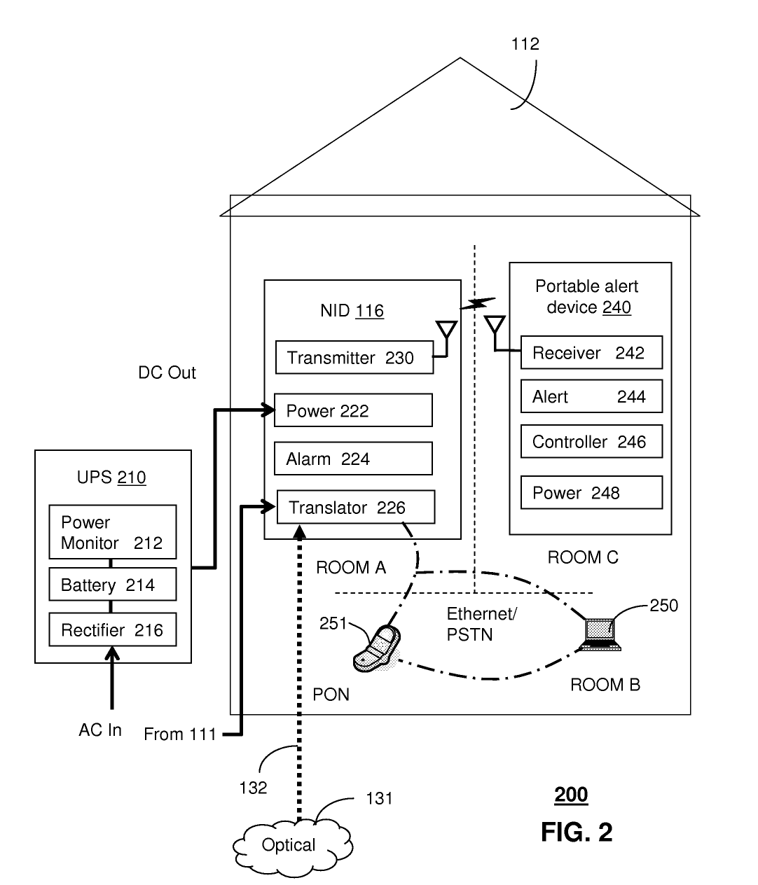

FIG. 2 depicts an exemplary embodiment of a communication system 200 operating in the residence 112. The communication system 200 can include an Uninterruptible Power Supply (UPS) 210 that receives power (e.g. Alternate Current (AC)) from local utilities, a rectifier 216 (e.g. AC to DC converter) that can charge one or more backup battery cells 214 and the NID 116, and a power monitor 212 that monitors operations of the UPS 214 and asserts one or more alarms when a malfunction such as a power failure of the UPS 214 is detected.

The UPS 210 can be a device separately coupled to the NID 116 as shown, or can be an integral part of a housing assembly of the NID 116 (not shown). As separate devices, the UPS 210 and the NID 116 can reside inside the residence 112 or outside of the residence in any combination coupled by common wiring techniques. In the present illustration, the UPS 210 is placed outside the residence 112, while the NID 116 is inside the residence. However, the UPS 210 can also be placed inside the residence 112 with the NID 116. As an integral device, the NID 116 (with its UPS 210) can similarly be located inside or outside the residence 112. In some instances the NID 116 and/or the UPS 210 may be at a location in or outside of the residence 112 which is not easily accessible and which is difficult to visually evaluate for failures asserted by the UPS 210.

The NID 116 can comprise a translator 226 that serves as a common optical and/or xDSL communications interface to supply communication services to one or more communication devices in the residence 112, such as the laptop 250 or phone 251. A communication device can also be a voice over IP (VoIP) phone, a PSTN phone, a desktop computer, a set-top-box, and/or a television set. The communication services can be packet or circuit-switched services. The NID 116 can further include a power element 222 that receives power from the UPS 210, and an alarm 224 that can receive and respond to a failure notice from the UPS 214. The NID 116 can also include a wireless transmitter 230 that utilizes common wireless transmission technology for transmitting wireless messages such as a notice of a fault in the UPS 210 to a portable alerting device 240 responsive to the UPS 210 asserting an alarm.

The portable alerting device 240 can be located anywhere in the residence 112 and can be powered by a portable power supply 248 operating from by a common battery and/or a fixed power supply coupled to an AC power source. In contrast to the flexibility of positioning the portable alerting device 240, the NID 116 and the UPS 210 are generally located at or near an internal and/or external power line, and the communication links 111. The portable alerting device 240 can further include a wireless receiver 242, an alert element 244, and a controller element 246 that manages operations of the portable alerting device. The wireless receiver 242 of the portable alerting device 240 and the wireless transmitter 230 of the NID 116 can communicate utilizing short-range wireless access technologies such as Bluetooth, Zigbee, or WiFi. With any one of these communication protocols, the NID 116 and the portable alerting device 240 can detect each others presence and establish communications.

The alert element 244 can utilize common technologies for supplying an audible, tactile or visual alerts to inform an end user of an alert state associated with the UPS 210. The alert element 244 can comprise an audio system, a vibrator, an LCD display and/or LEDs with associated alert state text. The audible alert can be a periodic or continuous tone (“beep” or “monotone”), or playback of a recorded alarm message (“the UPS has experienced a failure, please inspect”). Alternatively, or in combination, the alert can be a vibration that can be felt by the end user and which can be described by the LEDs and its associated text and/or a message in the LCD display.

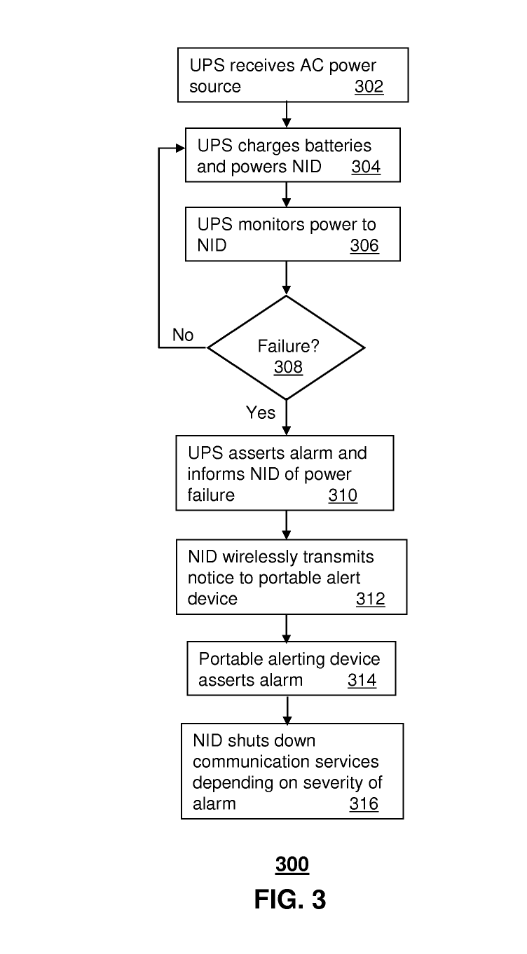

FIG. 3 depicts an exemplary method 300 operating in portions of communication system 100. The method 300 can be practiced with more or less than the number of steps shown. Moreover, method 300 is not limited to the order of the steps shown and other embodiments are herein contemplated. The method 300 can begin with step 302 in which the UPS 210 receives AC power from a local utility or from another power source and supplies DC power to charge its backup batteries and to power the NID 116, as shown in step 304. The UPS 210 can, in step 306, monitor operations and assert an alarm if a failure in the UPS 210 is detected. A failure can include a loss of power detected in the AC power source, a lack of presence of at least one backup battery cell, or a low battery level detected in a backup battery cell which can indicate that one or more of the battery cells needs to be replaced. The power monitor 212 can utilize common detection technology for detecting the above failures. It would be evident by an artisan of ordinary skill in the art that the power monitor 212 can also monitor other potential operational failures of the UPS. Accordingly, the present disclosure contemplates these other embodiments.

In step 308, the UPS 210 monitors for one of the aforementioned failures, and if a failure is detected, the UPS 210 asserts in step 310 an alarm which is directed to the NID 116 by wire coupling as shown in FIG. 2. The NID 116 in turn, at step 312, can wirelessly transmit a notice to the portable alerting device 240 to notify a user of the failure. In one aspect, the alarm message presented to the portable alerting device 240 can identify a fault in the UPS 210 (such as a power failure), a cause for the failure, and a time of the failure, or any other status indicator available to the UPS 210. The portable alerting device 240 in step 314 asserts a visual, audible, and/or tactile as noted earlier which describes the failure based on the information supplied by the NID 116.

Upon sending the notice of the failure to the portable alerting device 240 at step 312, or upon receiving a notice from the UPS 210 of a failure at step 310, the NID 210 can proceed to shutdown a portion of communication services as shown in step 316. As an example, the NID 210 can shut down services in order of priority based on the severity of the failure. For instance, if there is a power failure, the NID 210 can order a shutting down of high power consumption services except telephony services such as POTS or VoIP communications. If a backup battery in the UPS 210 is absent or inoperable, but power to the NID 210 is still available (i.e., there is no power failure) communication services continue uninterrupted.

The above embodiments of method 300 provide a means to conveniently monitor alarms asserted by the UPS 210 no matter where the UPS 210 and corresponding NID 116 are located in the residence.

From the foregoing descriptions, it would be evident to an artisan with ordinary skill in the art that the aforementioned embodiments can be modified, reduced, or enhanced without departing from the scope and spirit of the claims described below. For example, the portable alerting device 240 can be an integral part of a common computing device such as a laptop computer or desktop computer utilizing complementary wireless access technology as the transmitter 230 of the NID 116 (e.g., WiFi or Zigbee). In this embodiment, a simple software client can be added to the computing device to follow method 300 and to assert an audible or visual alarm when a failure is detected in the UPS 210. Moreover, the computing device can be programmed to submit an email or short message service (SMS) message to a cell phone. In this latter embodiment, a service provider of the communication system 100 can reduce cost by reusing existing computing technology of a subscriber.

These are but a few examples of how the embodiments described herein can be updated without altering the scope of the claims below. Accordingly, the reader is directed to the claims for a fuller understanding of the breadth and scope of the present disclosure.

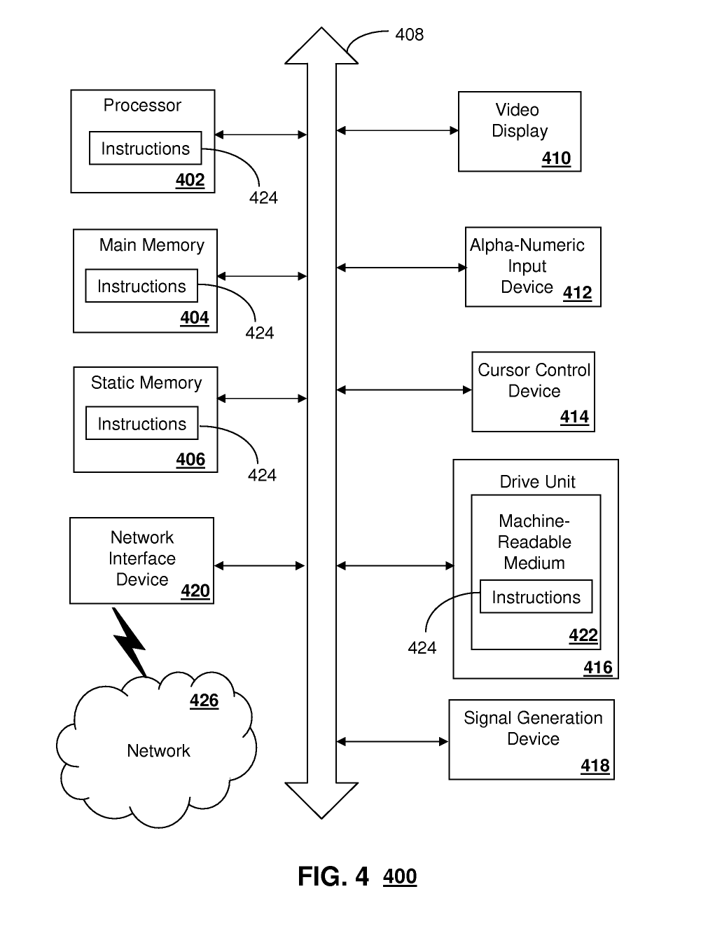

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a mass storage medium 416, a signal generation device 418 (e.g., a speaker or remote control) and a network interface device 420.

The mass storage medium 416 may include a computer-readable storage medium 422 on which is stored one or more sets of instructions (e.g., software 424) embodying any one or more of the methodologies or functions described herein, including those methods illustrated above. The computer-readable storage medium 422 can be an electromechanical medium such as a common disk drive, or a mass storage medium with no moving parts such as Flash or like non-volatile memories. The instructions 424 may also reside, completely or at least partially, within the main memory 404, the static memory 406, and/or within the processor 402 during execution thereof by the computer system 400. The main memory 404 and the processor 402 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the computer-readable storage medium 422 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A network interface device (NID), comprising:
a translator element that converts an optical signal supplied by a communication system to one or more electrical signals supplied to one or more communication devices operating in a building served by the NID;
an uninterrupted power supply (UPS) coupled to an AC power source; and
a wireless transmitter coupled to the UPS, wherein the wireless transmitter transmits a notice to a portable alerting device located in the building responsive to the UPS asserting an alarm.

2. The NID of claim 1, wherein the optical signal is supplied by a passive optical network (PON).

3. The NID of claim 1, wherein the one or more electrical signals comprise at least one among an Ethernet signal, and a public switched telephone network (PSTN) signal.

4. The NID of claim 1, wherein the alarm asserted by the UPS comprises at least one among a loss of power supplied by the AC power source, lack of presence of at least one backup battery cell, and low battery level detected in at least one of the at least one backup battery cell.

5. The NID of claim 1, wherein the portable alerting device is powered by at least one among a portable battery, and another AC power source, wherein the portable alerting device is located in the building, and wherein the NID is located at or near the building.

6. The NID of claim 1, wherein the wireless transmitter utilizes a short-range wireless access technology.

7. The NID of claim 6, wherein the short-range wireless access technology operates according to one among a group of access protocols comprising Bluetooth, Zigbee, and WiFi.

8. The NID of claim 1, wherein the translator element comprises a multiplexer and demultiplexer, and wherein the communication system comprises in part a central office housing one or more network elements for transporting data between the one or more communication devices in the building and other communication devices coupled to the communication system.

9. A uninterrupted power supply (UPS), comprising:
one or more battery cells to supply power to a network interface card (NID) during a power outage, wherein the NID is coupled to an optical communications interface and supplies communication services to one or more communication devices;
an AC to DC converter to charge the one or more battery cells and power the NID; and
a controller element to monitor operations of the UPS and assert one or more alarms when a malfunction is detected, wherein the one or more alarms are detected by the NID, and wherein the NID wirelessly transmits said alarms to a portable alerting device.

10. The UPS of claim 9, wherein the optical communications interface is part of a passive optical network (PON), and wherein the communication services comprise at least one among Ethernet services, and public switched telephone network (PSTN) services.

11. The UPS of claim 9, wherein the one or more alarms asserted by the controller element comprise at least one among a loss of power supplied by the AC to DC converter, lack of presence of at least one of the one or more battery cells, and low battery level detected in at least one of the one or more battery cells.

12. The UPS of claim 9, wherein the portable alerting device is powered by at least one among a portable battery, and another AC power source.

13. The UPS of claim 9, wherein the NID utilizes a short-range wireless access technology.

14. The UPS of claim 13, wherein the short-range wireless access technology operates according to one among a group of access protocols comprising Bluetooth, Zigbee, and WiFi.

15. The UPS of claim 9, wherein the one or more communication devices comprises at least one among a voice over IP (VoIP) phone, a PSTN phone, a computer, a set-top-box, and a television set.

16. A portable alerting device, comprising:
a wireless receiver;
an alert element; and
a controller element to receive from the wireless receiver an alarm notice associated with an uninterrupted power supply (UPS) and direct the alert element to assert an alert.

17. The portable alerting device of claim 16, comprising at least one among a portable power supply and an AC to DC converter for supplying power to the components of the portable alerting device, and wherein the wireless receiver receives one among Bluetooth, WiFi, and Zigbee signals from one among the UPS and a Network Interface Device (NID) corresponding to the alarm notice.

18. The portable alerting device of claim 16, wherein the NID is coupled to an optical communications interface and supplies communication services to one or more communication devices in a building, and wherein the portable alerting device is located in the building.

19. The portable alerting device of claim 16, wherein the alert corresponds to at least one among an audible, tactile and visual alert to inform an end user that the UPS has a fault.

20. The portable alerting device of claim 19, wherein the fault experienced by the UPS comprises at least one among a loss of power supplied by an AC power source to the UPS, lack of presence of at least one backup battery cell of the UPS, and low battery level detected in at least one of the at least one backup battery cell.

21. A network interface device (NID), comprising:
a translator element to convert an optical signal supplied by a communication system to one or more electrical signals supplied to one or more communication devices served by the NID; and
a wireless transmitter to transmit a notice to a portable alerting device responsive to an uninterrupted power supply (UPS) asserting an alarm.
